(19) United States
(12) Patent Application Publication
(10) Pub. No.: US 2026/0249196 A1
(43) Pub. Date: Aug. 27, 2026

(54) INFORMATION PROCESSING DEVICE AND GAMEPLAY CONTROL METHOD

(71) Applicant: Sony Interactive Entertainment Inc., Tokyo (JP)

(72) Inventor: Tsuyoshi Ono, Tokyo (JP)

(73) Assignee: Sony Interactive Entertainment Inc., Tokyo (JP)

(21) Appl. No.: 19/163,691

(22) PCT Filed: Mar. 31, 2023
(86) PCT No.: PCT/JP2023/013552

§ 371 Date: Sep. 9, 2025

(51) Int. Cl. A63F 13/70

(52) U.S. Cl. CPC A63F 13/70

(57) ABSTRACT

A restriction information holding section 130 holds first restriction information indicating a first restriction condition for restricting daily gameplay of a user, and second restriction information indicating a second restriction condition for restricting the daily gameplay of the user from a viewpoint different from the first restriction condition. An execution section 116 executes a game according to an operation input of the user. A restriction processing section 112 determines whether or not a situation of the gameplay of the user satisfies the first restriction condition and/or the second restriction condition, and restricts the gameplay of the user according to a result of the determination.

### TECHNICAL FIELD

The present disclosure relates to a technique for controlling gameplay of a user.

### BACKGROUND ART

PTL 1 discloses a system for establishing a family group to which members of a family belong. The members who belong to the family group are divided into adults and children, and a family manager can set contents of parental control on a child and change the settings as needed. PTL 1 discloses an item for setting a time limit for gameplay (play permission time) for a child per day as an item of parental control.

### CITATION LIST

### Patent Literature

### PTL 1

PCT Patent Publication No. WO2019/021888

### SUMMARY

### Technical Problem

In a case in which a daily play permission time is set, when a total play time for one day reaches the daily play permission time, the conventional game device forcibly ends the game, and restricts (prohibits) gameplay by a child. PTL 1 discloses a technique for notifying a user of a message indicating the remaining time, when there are only five minutes of playtime left. However, for example, in a situation in which the user is playing a match with another player or has just started a boss battle, it may be difficult to finish playing the game in five minutes, and to forcibly end the game in such a case is harsh on the user.

In view of this, an object of the present disclosure is to provide a technique for controlling gameplay of a user with use of a flexible parental control function.

### Solution to Problem

An aspect of the present disclosure is an information processing device including one or more processors having hardware. The one or more processors having hardware restrict gameplay of a user according to a result of a determination whether or not a situation of the gameplay of the user satisfies a first restriction condition for restricting daily gameplay of the user and/or a second restriction condition for restricting the daily gameplay of the user from a viewpoint different from the first restriction condition.

Another aspect of the present disclosure is a method of controlling gameplay in an information processing device. In this method, gameplay of a user is restricted according to a result of a determination whether or not a situation of the gameplay of the user satisfies a first restriction condition for restricting daily gameplay of the user and/or a second restriction condition for restricting the daily gameplay of the user from a viewpoint different from the first restriction condition.

Any combinations of the components described above and the expressions of the present disclosure that are converted between a method, a device, a system, a recording medium, a computer program, and the like are also effective as aspects of the present disclosure.

### BRIEF DESCRIPTION OF DRAWINGS

FIG. 1 is a diagram illustrating an information processing system according to an embodiment.

FIG. 2 is a diagram illustrating a hardware configuration of a first information processing device.

FIG. 3 is a diagram illustrating functional blocks of the first information processing device.

FIG. 4 is a diagram illustrating an example of a setting screen regarding the parental control.

FIG. 5 is a diagram illustrating another example of the setting screen regarding the parental control.

FIG. 6 is a diagram illustrating an example of a game image.

FIG. 7 is a diagram illustrating a flowchart for performing a parental control function according to a first example.

FIG. 8 is a diagram illustrating still another example of the setting screen regarding the parental control.

FIG. 9 is a diagram illustrating yet another example of the setting screen regarding the parental control.

FIG. 10 is a diagram illustrating a flowchart for performing the parental control according to a second example.

FIG. 11 is a diagram illustrating an example of a notification message.

FIG. 12 is a diagram illustrating an example of the setting screen regarding the parental control for setting a second restriction condition.

### DESCRIPTION OF EMBODIMENT

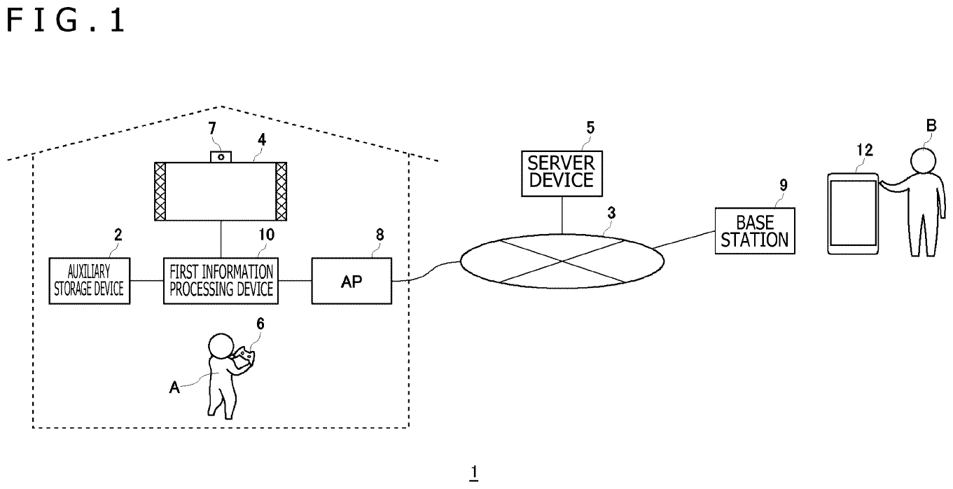

FIG. 1 illustrates an information processing system 1 according to an embodiment of the present disclosure. The information processing system 1 includes a first information processing device 10 used by a user A, a second information processing device 12 used by a user B, a base station 9, and a server device 5. An access point (hereinafter, referred to as an “AP”) 8 has functions of a wireless access point and a router, and the first information processing device 10 is connected to the AP 8 wirelessly or with a cable and is connected so as to be communicated with the server device 5 and the second information processing device 12 through a network 3.

The first information processing device 10 is a game device provided with a parental control function and may be either a non-portable or a portable type. In the embodiment, the user A is a child who is subject to parental control, and the user B is a parent of the user A with the right to set the parental control function.

The first information processing device 10 connects to an input device 6 operated by a user wirelessly or with a cable, and the input device 6 outputs operation information of the user to the first information processing device 10. When receiving the operation information from the input device 6, the first information processing device 10 reflects the operation information on processing of system software or a game program, and then outputs a result of the processing from the output device 4. The input device 6 is such a device as a game controller that provides the operation information of the user to the first information processing device 10. Note that the input device 6 may be an input interface such as a keyboard or a mouse. In the embodiment, when an event occurs in a game, the game program outputs event information including information (event ID) for identifying the event having occurred to the system software.

The second information processing device 12 may be a portable terminal device such as a mobile phone, a smartphone, or a tablet and connects to the base station 9 so as to be communicated with the server device 5 and the first information processing device 10 through the network 3. Note that the second information processing device 12 may be a non-portable terminal device. The user B operates the second information processing device 12, allowing the parental control function of the first information processing device 10 to be remotely set or changed. Note that, although the user B is present in a place remote from his/her home in FIG. 1, it is also possible to set or change the parental control function of the first information processing device 10 at home by directly operating the first information processing device 10.

An auxiliary storage device 2 is a large-capacity recording device such as a hard disk drive (HDD) or a solid state drive (SSD), functions as a part of a configuration of the first information processing device 1. The auxiliary storage device 2 may be a built-in recording device or an external recording device that is connected to the first information processing device 10 by a universal serial bus (USB) or the like. The output device 4 may be a television set including a display for outputting images and a speaker for outputting sounds. The output device 4 may be connected to the first information processing device 10 by a wired cable or may be connected thereto in a wireless manner.

The camera 7 which is an imaging device is provided in the vicinity of the output device 4 and captures an image of a space around the output device 4. While FIG. 1 illustrates an example in which the camera 7 is mounted to an upper part of the output device 4, the camera 7 may be disposed on a side part or a lower part of the output device 4; in any case, the camera 7 is disposed at a position where the camera 7 can capture an image of the user who is positioned in front of the output device 4. The camera 7 may be a stereo camera.

A server device 5 provides a network service to the users of the information processing system 1. The server device 5 may physically include a plurality of servers, and each of the servers may be maintained or managed by entities according to respective functions. The server device 5 manages a network account for identifying the user, and the user signs in to the server device 5 by using the network account. The users A and B sign in to the server device 5, thereby being able to receive various types of services.

The game includes a plurality of activities each of which has a start condition and an end condition set thereto. An activity is one play unit that is incorporated in the game and that includes a stage, a quest, a mission, a tournament, a session, or the like. A game progress from a point in time at which the start condition is fulfilled to a point in time at which the end condition is fulfilled constitutes one activity. Activities are set by a game developer as needed, and one quest appearing in the progress of the game may constitute one activity.

When a certain activity is started, the game program outputs event information including information (event ID) for identifying a start event of the relevant activity to the system software. In addition, when a certain activity is ended, the game program outputs event information including information (event ID) for identifying an end event of the relevant activity to the system software. The event information may include not only the event ID, but also information (activity ID) for identifying an activity, and may include information indicating a result of performing an activity (for example, success or failure). The event ID is set so as to be different from each event. The activity ID is set so as to be different from each activity.

The system software generates play data by adding, to the event information output from the game program, the user identifier (user account) for identifying the user, the game identifier (game ID) for identifying the game, and the time information (time stamp), and automatically transmits the generated play data to the server device 5 in real time.

The server device 5 collects and accumulates pieces of play data transmitted from a plurality of first information processing devices 10 operated by a plurality of players. The server device 5 reads out the respective time stamps from the play data of the start event of an activity and the play data of the end event of the relevant activity, to thereby calculate a length of play time for the relevant activity (play time). The server device 5 averages the lengths of play time of the plurality of players for each game, and may calculate the average play time for the activity in each game. Also, the server device 5 averages the lengths of play time of the plurality of players for each activity, thereby also being able to calculate the average play time for each activity. Also, in a case in which activities are sorted into any one of multiple types, the server device 5 may calculate the average play time for the activity for each activity type. The average play time thus calculated can be used as an estimated play time for an activity. Note that the server device 5 performs statistical processing on the play time for the activity according to a player's skill, so that the server device 5 may calculate the estimate play time according to the player's skill.

In the embodiment, the first information processing device 10 holds control information indicating a restriction condition for restricting daily gameplay of the user A in order to execute the parental control function. As described later, the first information processing device 10 may hold control information indicating different types of multiple restriction conditions. The first information processing device 10 determines whether or not the situation of gameplay of the user A satisfies any of the restriction conditions, and restricts the gameplay of the user A according to a result of the determination.

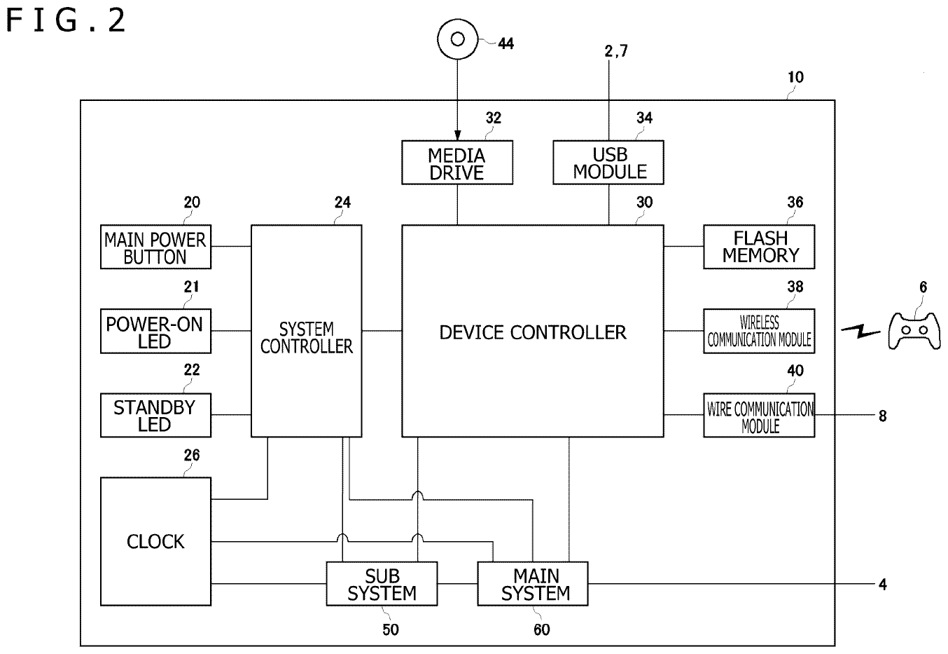

FIG. 2 illustrates a hardware configuration of the first information processing device 10. The first information processing device 10 includes a main power supply button 20, a power-ON light emitting diode (LED) 21, a standby LED 22, a system controller 24, a clock 26, a device controller 30, a media drive 32, a USB module 34, a flash memory 36, a wireless communication module 38, a wire communication module 40, a sub system 50, and a main system 60.

The main system 60 includes a main central processing unit (CPU), a memory which is a main storage device, a memory controller, a graphics processing unit (GPU), etc. The GPU is mainly used in arithmetic processing for a game program. Those functions may be configured as a system-on-chip and formed on one chip. The main CPU has a function for executing a game program recorded in the auxiliary storage device 2.

The sub system 50 includes a sub CPU, a memory that is a main storage device, a memory controller, and the like, but does not include a GPU and does not have a function for executing a game program. The number of circuit gates of the sub CPU is smaller than the number of the circuit gates of the main CPU, and the operation power consumption of the sub CPU is lower than the operation power consumption of the main CPU. The sub CPU operates also while the main CPU is in a standby state and is limited in processing function thereof so as to suppress the power consumption low.

The main power supply button 20 is an input unit through which an operation input is performed by a user and is provided on a front face of the casing of the first information processing device 10. The main power supply button 20 is operated in order to turn on or off power supply to the main system 60 of the first information processing device 10. The power-ON LED 21 is lit when the main power supply button 20 is turned on, and the standby LED 22 is lit when the main power supply button 20 is turned off.

The system controller 24 detects depression of the main power supply button 20 by a user. If the main power supply button 20 is depressed when the main power supply is in an off state, the system controller 24 acquires the depression operation as a “turn on instruction,” but if the main power supply button 20 is depressed when the main power supply is in an on state, the system controller 24 acquires the depression operation as a “turn off instruction.”

The clock 26 is a real time clock, generates date and time information at present, and supplies the generated information to the system controller 24, the sub system 50, and the main system 60. The device controller 30 is configured as a large-scale integrated circuit (LSI) which executes delivery of information between devices like a south bridge. As depicted in the figure, such devices as the system controller 24, the media drive 32, the USB module 34, the flash memory 36, the wireless communication module 38, the wire communication module 40, the sub system 50, and the main system 60 are connected to the device controller 30. The device controller 30 accommodates a difference in electric characteristic or a difference in data transfer rate between the devices and controls the timing of data transfer.

The media drive 32 is a drive device which is loaded with and drives the read-only memory (ROM) medium 44 on which application software such as a game and license information are recorded, and reads a program, data, and the like from the ROM medium 44. The ROM medium 44 is a read-only recording medium such as an optical disc, a magneto-optical disc, or a Blu-ray disc.

The USB module 34 is a module connected to external equipment by a USB cable. The USB module 34 may be connected to the auxiliary storage device 2 and the camera 7 by a USB cable. The flash memory 36 is an auxiliary storage device forming an internal storage. The wireless communication module 38 performs wireless communication, for example, with the input device 6 under a communication protocol such as a Bluetooth (registered trademark) protocol or an Institute of Electrical and Electronics Engineers (IEEE) 802.11 protocol. The wire communication module 40 performs wire communication with external equipment and is connected to the network 3 outside, for example, through the AP 8.

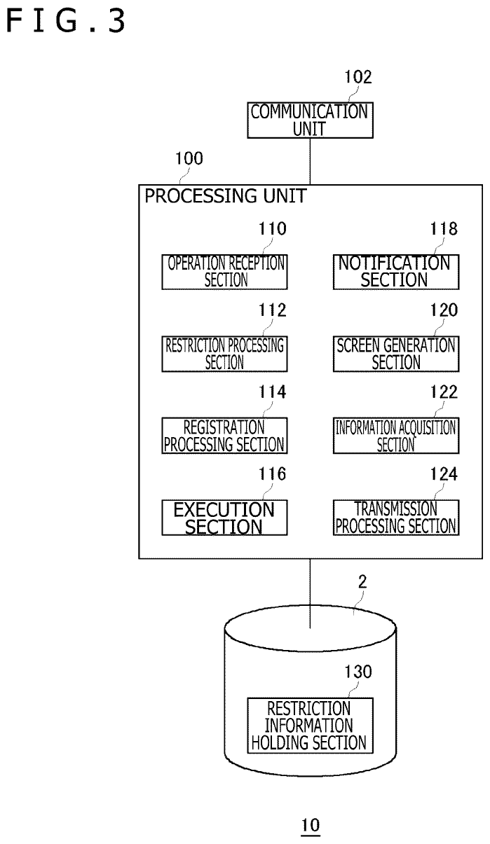

FIG. 3 illustrates functional blocks of the first information processing device 10. The first information processing device 10 includes a processing section 100 and a communication section 102. The first information processing device 10 may include the auxiliary storage device 2 as a part of the configuration. The processing section 100 includes an operation reception section 110, a restriction processing section 112, a registration processing section 114, an execution section 116, a notification section 118, a screen generation section 120, an information acquisition section 122, and a transmission processing section 124. The communication section 102 indicates functions of the wireless communication module 38 and the wire communication module 40 illustrated in FIG. 2. The auxiliary storage device 2 has the restriction information holding section 130 that holds restriction information regarding parental control. The restriction information is information indicating a condition for restricting daily gameplay of the user A.

The first information processing device 10 includes a computer, and various functions illustrated in FIG. 3 are implemented when the computer executes programs. The computer includes, as hardware, a memory to which programs are to be loaded, one or more processors that execute the programs loaded, an auxiliary storage device, other LSIs, and the like. The processor includes a plurality of electronic circuits including semiconductor integrated circuits and LSIs. The plurality of electronic circuits may be mounted onto one chip or may be mounted onto a plurality of chips. The functional blocks illustrated in FIG. 3 are implemented by cooperation between hardware and software. Accordingly, it should be understood by those skilled in the art that these functional blocks can be implemented in various forms including hardware only, software only, or a combination of the two.

### First Example

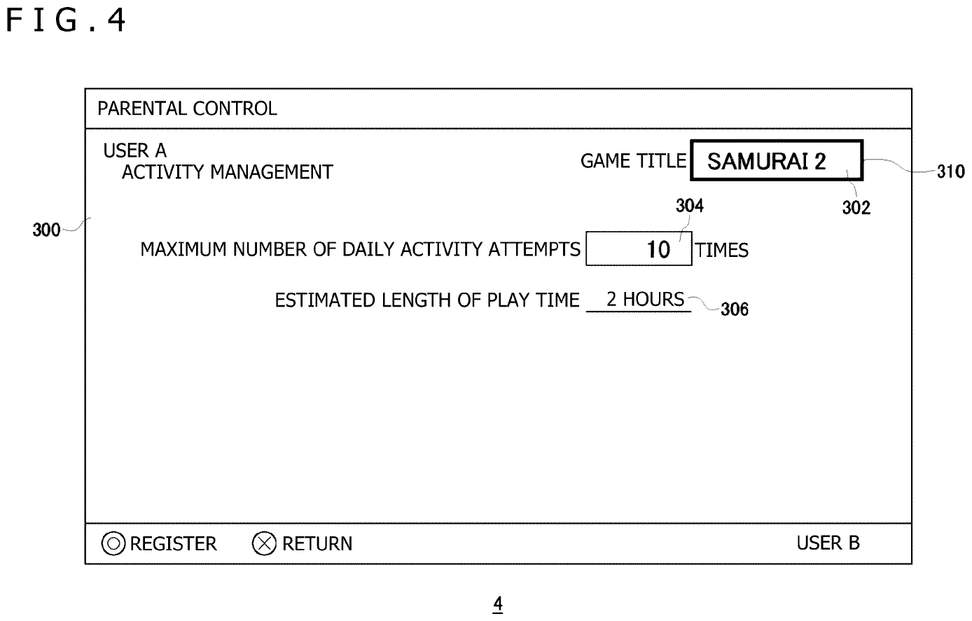

FIG. 4 illustrates an example of a setting screen of parental control. The screen generation section 120 displays a parental control setting screen 300 for setting a restriction condition regarding parental control on the output device 4. Here, the user B operates the first information processing device 10 to set the restriction condition regarding parental control and can also operate the second information processing device 12 such as a smartphone to set the restriction condition regarding parental control. In the first example, the user B sets the restriction condition for restricting daily gameplay of the user A for each game title.

On the parental control setting screen 300, a title specifying field 302 is a region for specifying a game title on which play restriction is to be imposed. The user B inputs a game title on which play restriction is to be imposed in the title specifying field 302. For example, when the user B operates the input device 6 to move a focus frame 310 on the title specifying field 302, a list of the game titles installed in the auxiliary storage device 2 is displayed, and the user B may specify a game title on which play restriction is to be imposed, by selecting the game title from among the list of the game titles. In this example, a game title “SAMURAI2” is input in the title specifying field 302.

A number input filed 304 is a region for setting the maximum number of times the user A can perform an activity per day. When the user B operates the input device 6 to move the focus frame 310 on the number input filed 304, it is possible to input the maximum number of activity attempts in the number input filed 304. In the example illustrated in FIG. 4, the number input filed 304 has “10” set therein, and this means that the user A can perform an activity in the game title “SAMURAI2,” up to ten per day.

In an estimated play time display field 306, an estimated value of play time taken when an activity is performed 10 times is displayed. Hence, according to the maximum number of activity attempts which is to be input in the number input filed 304, the estimated play time that is displayed in the number input filed 304 varies. When the maximum number of activity attempts is input in the number input filed 304, the registration processing section 114 queries the server device 5 for the estimated play time taken when the user A performs the activity of the title “SAMURAI2” the maximum number of times (10 in this case). The server device 5 calculates the estimated play time with use of the average play time for the activity of the title “SAMURAI2,” providing the estimated play time to the first information processing device 10. For example, when the average play time of the activity of the title “SAMURAI2” is 12 minutes, the estimated play time taken when the activity is performed 10 times is calculated to be 120 minutes (2 hours), and in the example illustrated in FIG. 4, “2 hours” is displayed in the estimated play time display field 306. Note that the estimated play time displayed in the estimated play time display field 306 is reference information only as a reference value and cannot be considered an accurate estimated play time. However, for example, if the user B decides that the estimated play time displayed in the estimated play time display field 306 is long, it is only sufficient if the maximum number of activity attempts input in the number input filed 304 is reduced.

After the user B inputs the maximum number of the activity attempts in the number input filed 304, when a predetermined button of the input device 6 (for example, o button) is operated, the registration processing section 114 registers information set on the parental control setting screen 300 in the restriction information holding section 130, as restriction information indicating the restriction condition for imposing restriction on daily gameplay of the user A. In the example illustrated in FIG. 4, the registration processing section 114 registers the restriction information indicating that the maximum number of activity attempts for the title “SAMURAI2” is 10 in the restriction information holding section 130. The user B opens up the parental control setting screen 300 in the first information processing device 10 or the second information processing device 12 and can update the restriction information any time.

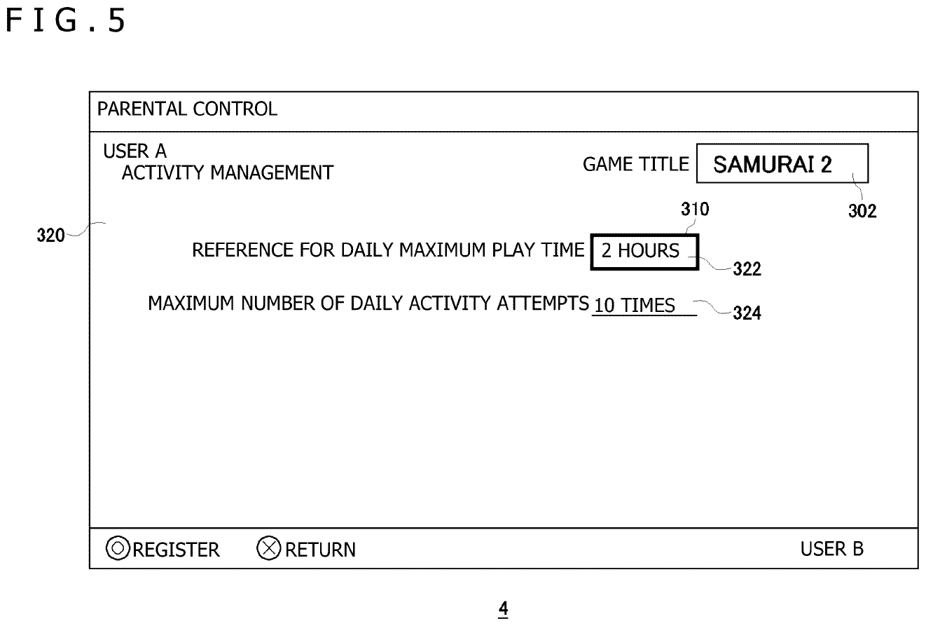

FIG. 5 indicates another example of the setting screen for parental control. The screen generation section 120 displays a parental control setting screen 320 for setting the restriction condition regarding parental control on the output device 4. On the parental control setting screen 320, a time input field 322 is a region for setting a reference value for the daily maximum play time of the user A. In the example illustrated in FIG. 5, the time input field 322 has “2 hours” set therein.

When the reference value for the maximum play time is input in the time input field 322, the registration processing section 114 queries the server device 5 for how many times the activity of the title “SAMURAI2” can be performed for the maximum play time (for 2 hours, in this case). The server device 5 calculates the number of activity attempts with use of the average play time for the activity of the title “SAMURAI2,” thereby providing the calculated result to the first information processing device 10. When the average play time for the activity of the title “SAMURAI2” is 12 minutes, it is calculated that the user can perform the activity 10 times in 2 hours, and in the example illustrated in FIG. 5, “10 times” is displayed in a number display field 324. In this manner, on the parental control setting screen 320, the user B inputs the reference value for the maximum play time in the time input field 322, so that it is possible to set the maximum number of times the user A can perform the activity per day (10 in this case).

After the user B inputs the reference value for the maximum play time in the time input field 322, a predetermined button (for example, o button) of the input device 6 is operated, and the registration processing section 114 registers information set on the parental control setting screen 320 in the restriction information holding section 130, as the restriction information indicating the restriction condition for imposing restriction on daily gameplay of the user A. In the example illustrated in FIG. 5, the registration processing section 114 registers the restriction information indicating that the maximum number of activity attempts is 10 in the restriction information holding section 130. The user B opens up the parental control setting screen 320 in the first information processing device 10 or the second information processing device 12, so that the user B can update the restriction information any time.

Referring back to FIG. 3, a system for establishing control on gameplay by the user A.

The operation reception section 110 receives operation input of the input device 6 by the user A through the communication section 102. The execution section 116 executes the game according to the operation input by the user. Specifically, the execution section 116 executes a game program to generate a game image and a game sound, and outputs the generated game image and game sound from the output device 4. A function indicated as the execution section 116 is implemented by system software, a game program, or hardware such as a GPU which executes rendering or the like.

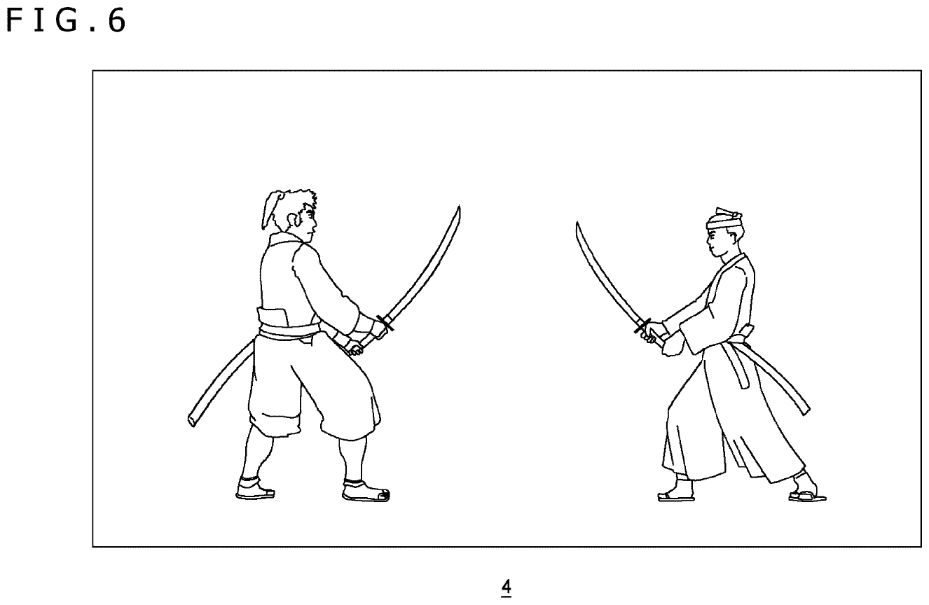

FIG. 6 illustrates one example of a game image displayed on the output device 4. During gameplay by the user, when an activity is started, the game program outputs event information including information (event ID) for identifying the start event of the relevant activity to the information acquisition section 122. In addition, when the activity is ended, the game program outputs event information including information (event ID) for identifying the end event of the relevant activity to the information acquisition section 122.

When acquiring the event information, the information acquisition section 122 generates play data obtained by adding a user account, a game ID, and a time stamp to the event information, and provides the generated play data to the transmission processing section 124. The game program may output the event information including the game ID and/or the time stamp to the information acquisition section 122. The transmission processing section 124 transmits the play data provided from the information acquisition section 122 through the communication section 102 to the server device 5 in real time. As described above, the server device 5 collects pieces of play data regarding activities, and calculates the average play time for activities of the game, the average play time for each activity, and the average play time for each type of activities in the game.

When acquiring the event information indicating the start of the activity, the information acquisition section 122 provides the acquired event information to the restriction processing section 112. Also, when acquiring the event information indicating the end of the activity, the information acquisition section 122 provides the acquired event information to the restriction processing section 112. The restriction processing section 112 is provided with the event information regarding the activity from the information acquisition section 122, so that the user A can count the number of activity attempts per day in real time.

Note that the restriction processing section 112 may be provided with the event information regarding the activity from the server device 5. As described above, the transmission processing section 124 transmits play data to the server device 5 in real time. Accordingly, in the first information processing device 10, in a case in which the information acquisition section 122 has a function of providing the event information to the restriction processing section 112, the restriction processing section 112 receives the event information regarding the activity from the server device 5, so that the user A can count the number of activity attempts per day in real time.

The restriction information holding section 130 holds the restriction information indicating the maximum number of daily activity attempts and in the first example, holds such restriction information that the maximum number of activity attempts for the title “SAMURAI2” is 10. When the counted number of activity attempts reaches the maximum number of daily activity attempts, the restriction processing section 112 restricts gameplay of the user. According to the first example, the user A can play the activity of the title “SAMURAI2” within the range of the maximum number. For example, compared to parental control under the conventional time restriction, the user A can continue the activity until the end without being forced to end the gameplay midway.

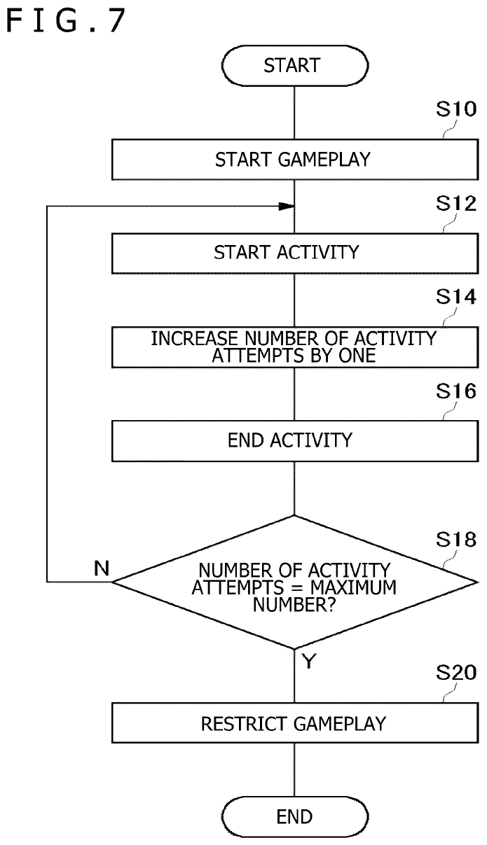

FIG. 7 indicates a flowchart of executing the parental control function in the first example. The parental control function in the first example monitors the situation of daily gameplay of the user A, and in a case in which the situation of the gameplay satisfies a predetermined restriction condition, restricts, for example, prohibits the user A from performing the gameplay.

When the user A starts to play the title “SAMURAI2” (S10) and the activity is started (S12), the restriction processing section 112 increases the number of activity attempts by one (S14). Prior to start of the gameplay, an initial value of the number of daily activity attempts is set to “0,” and accordingly, when the first round of activity is started, the number of activity attempts is “1.” When being provided with event information indicating that the activity has been started, the restriction processing section 112 may determine that the activity has been started. When the activity is ended (S16), the restriction processing section 112 determines whether or not the counted number of activity attempts reaches the maximum number (S18). When being provided with event information indicating that the activity has been ended, the restriction processing section 112 may determine that the activity has been ended.

In step S18, the restriction processing section 112 acquires the restriction information indicating the maximum number of activity attempts of the user A from the restriction information holding section 130. In a case in which the counted number of activity attempts is smaller than the maximum number (N in step S18), the restriction processing section 112 does not restrict the gameplay. Conversely, in a case in which the counted number of activity attempts reaches the maximum number (Y in step S18), the restriction processing section 112 forcibly ends the game, and restricts the gameplay of the user A (S20).

According to the first example, the user A can perform the activity within the range of the maximum number set by the user B. Hence, a situation in which the activity currently being performed is forcibly ended midway is not generated, and the user A can enjoy the activity. Note that, in step S14, the restriction processing section 112 increases the number of activity attempts by one when the activity is started, but when the activity is ended, the number of activity attempts may be increased by one.

In the first example, the user B sets a restriction condition for imposing restriction on the daily gameplay of the user A for each game title. The user B may restrict the game title that the user A is allowed to play. For example, the user A may be allowed to play only a game title to which the user B sets the restriction condition and may not be allowed to play game titles with no restriction condition being set by the user B.

### Second Example

In the second example, a type is assigned to each activity, and the game developer is assumed to set one type to one activity.

Activities are classified into any of multiple types, and each activity has one type as attribute information.

In the second example, any one of the following three types are assigned to each of the activities.

### (Type 1) Multiplayer

The “multiplayer” type is assigned to an activity such as an online match.

### (Type 2) Progress

The “progress” type is, for example, assigned to an activity such as a quest or a mission which enables the user to try multiple times to succeed.

### (Type 3) Repeatable

The “repeatable” type is, for example, assigned to an activity such as a stage which has no restriction on the number of challenges.

The user B who is a parent can set the maximum number of activity attempts of the user A for each type of activities.

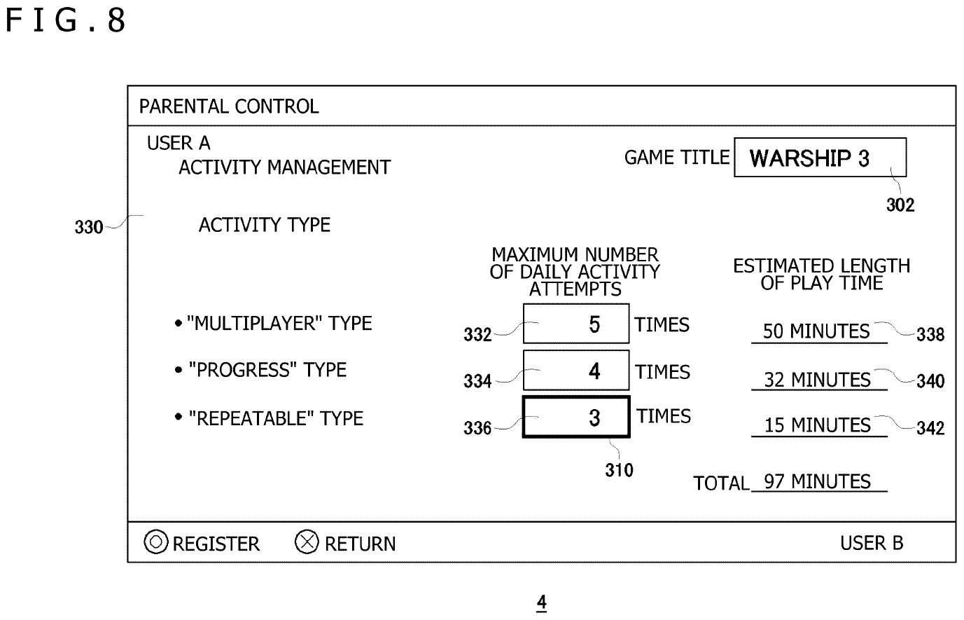

FIG. 8 illustrates another example of the setting screen of parental control. The screen generation section 120 displays a parental control setting screen 330 for setting the restriction condition regarding parental control on the output device 4. In the second example, the user B sets the restriction condition for restricting the daily gameplay of the user A for each activity type.

On the parental control setting screen 330, the title specifying field 302 is a region for specifying a game title on which play restriction is to be imposed. The user B inputs a game title on which play restriction is to be imposed, in the title specifying field 302. In this example, a game title “WARSHIP3” is input in the title specifying field 302.

A number input fields 332, 334, and 336 are regions for setting the maximum number of daily activity attempts of the user A, for each activity type. The number input field 332 is a region for setting the maximum number of daily activity attempts for the “multiplayer” type, the number input field 334 is a region for setting the maximum number of daily activity attempts for the “progress” type, and the number input field 336 is a region for setting the maximum number of daily activity attempts for the “repeatable” type. The user B operates the input device 6 to move the focus frame 310 on each of the number input fields, and inputs the maximum number of the activity attempts in each of the number input fields. In the example illustrated in FIG. 8, “5” is set in the number input field 332, “4” is set in the number input field 334, and “3” is set in the number input field 336. This means that, in the game titled “WARSHIP3,” the user A can perform the “multiplayer” type activity five times a day, the “progress” type activity four times a day, and the “repeatable” type activity three times a day.

When the game title is input in the title specifying field 302, the registration processing section 114 may query the server device 5 for the activity type included in the input game title. As a result of the query, for example, in a case in which the activity type of the title “WARSHIP3” is the “multiplayer” type only, the registration processing section 114 does not allow the user to input any number in the number input fields for the types other than that, that is, in the number input field 334 for the “progress” type and in the number input field 336 for the “repeatable” type. In this manner, it is preferable that the registration processing section 114 does not allow the user to input any number in the number input field for a type which is not present. In the example illustrated in FIG. 8, activities of all types are included in the title “WARSHIP3,” and accordingly, the user B inputs the maximum numbers in all the number input fields 332, 334, and 336.

In the estimated play time display fields 338, 340, and 342, estimated values of play time taken when the user A performs the activities by the respective maximum numbers input in the number input fields 332, 334, and 336 are displayed. Hence, according to the maximum numbers input in the number input fields 332, 334, and 336, the estimated play times displayed in the estimated play time display fields 338, 340, and 342 vary. When the maximum numbers are input in the respective number input fields 332, 334, and 336, the registration processing section 114 queries the server device 5 for estimated play times taken when the activities of the title “WARSHIP3” are each performed the maximum number of times. The server device 5 calculates the estimated play time with use of the average play time for each activity type of the title “WARSHIP3,” and provides the calculated result to the first information processing device 10. In the example illustrated in FIG. 8, the estimated play time “50 minutes” is displayed in the estimated play time display field 338, the estimated play time “32 minutes” is displayed in the estimated play time display field 340, and the estimated play time “15 minutes” is displayed in the estimated play time display field 342. Note that the estimated play times displayed in the estimated play time display fields 338, 340, and 342 are reference information as a reference value only, and cannot be considered an accurate estimated time, but, for example, if the user B determines that the estimated play times displayed in the estimated play time display fields 338, 340, and 342 are short, by increasing the numbers input in the number input fields 332, 334, and 336, the estimated play times can be made longer.

After the user B inputs the maximum numbers in the number input fields 332, 334, and 336, when the user B operates a predetermined button (for example, o button) of the input device 6, the registration processing section 114 registers information set on the parental control setting screen 330, as the restriction information indicating the restriction condition for restricting the daily gameplay of the user A in the restriction information holding section 130. In the example illustrated in FIG. 8, the registration processing section 114 registers restriction information indicating that the maximum number of activity attempts for the “multiplayer” type is 5, the maximum number of activity attempts for the “progress” type is 4, and the maximum number of activity attempts for the “repeatable” type is 3, in the restriction information holding section 130. The user B opens up the parental control setting screen 330 in the first information processing device 10 or the second information processing device 12, so that the restriction information can be updated any time.

Note that, on the parental control setting screen 330, although the user B sets the maximum number of attempts for each activity type, two or more types which are allowed to play may be specified, and the maximum numbers of attempts for the specified two or more types of activities of may be set. In this case, the user A can perform the two or more types of activities which are allowed to play within a range of the set maximum number of times.

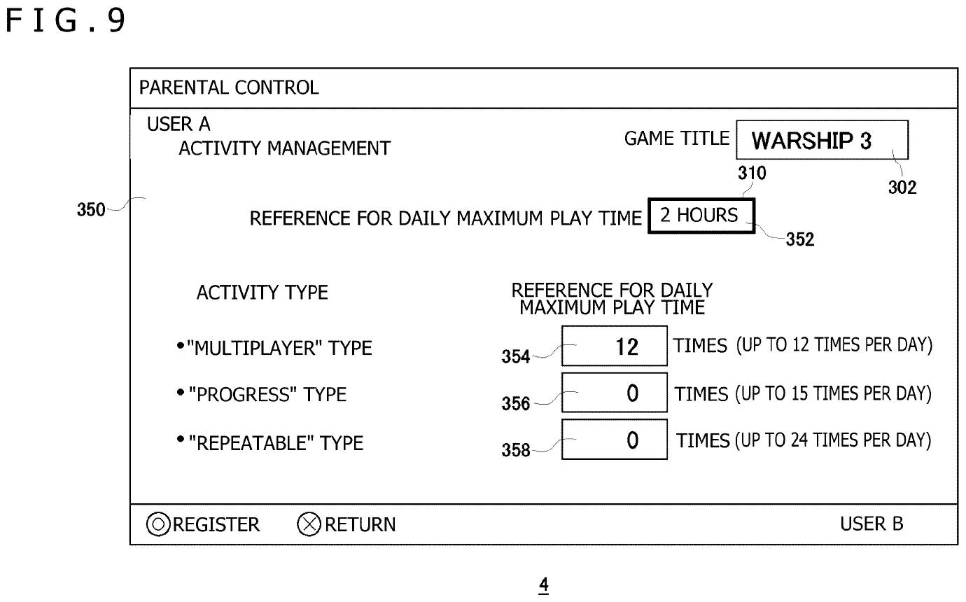

FIG. 9 illustrates another example of the setting screen of parental control. The screen generation section 120 displays the parental control setting screen 350 for setting the restriction condition regarding parental control on the output device 4. On the parental control setting screen 350, the time input field 352 is a region for setting the reference value for the maximum play time for which the user A plays per a day. In the example illustrated in FIG. 9, the play time “2 hours” is set in the time input field 352.

When the reference value for the maximum play time is input in the time input field 322, the registration processing section 114 queries the server device 5 for the average play time for each activity type of the title “WARSHIP3.” At this time, the server device 5 gives the first information processing device 10 answers that the average play time of the “multiplayer” type activity is 10 minutes, the average play time of the “progress” type activity is 8 minutes, and the average play time of the “repeatable” type activity is 5 minutes.

The registration processing section 114 calculates the number of attempts for each activity type, within the range of the maximum play time (2 hours) input in the time input field 352. Assuming that the number of attempts for the “multiplayer” type activity is “N1,” the number of attempts for the “progress” type activity is “N2,” and the number of attempts for the “repeatable” type activity is “N3,” the registration processing section 114 calculates the number of attempts for each activity type according to the following equation.

$$( maximum play time ) \geq ( 10 minutes \times N 1 ) + ( 8 minutes \times N 2 ) + ( 5 minutes \times N 3 )$$

In the example illustrated in FIG. 9, the registration processing section 114 calculates the number of attempts N1 (12 times) when the entire maximum play time is spent for performing the “multiplayer” type activity, and displays the calculated result on the number display field 354. At this time, the number of attempts N2 for the “progress” type activity is displayed as 0 in the number display field 356, and the number of attempts N3 for the “repeatable” type activity is displayed as 0 in the number display field 358. Note that the registration processing section 114 may calculate the number of attempts for each activity type when the maximum play time (2 hours) is equally allocated to the attempt for each activity type. In this case, the time of performing each activity is 40 minutes, and accordingly, the number of daily activity attempts is 4 in the number display field 354, 5 in the number display field 356, and 8 in the number display field 358.

The user B can manually change the maximum numbers displayed in the number display fields 354, 356, and 358. The registration processing section 114 may automatically change the number of attempts for other activity types, in such a manner that, when the user B changes the maximum number of attempts for any one of the activity types, the total play time of all the activity types becomes close to the maximum play time.

After the user B inputs the reference value for the daily maximum play time in the time input field 352 and the maximum number of times displayed in the number display fields 354, 356, and 358 is adjusted, when a predetermined button of the input device 6 (for example, ○ button) is operated, the registration processing section 114 registers information set on the parental control setting screen 350 in the restriction information holding section 130, as the restriction information indicating the restriction condition for restricting daily gameplay of the user A. In the example illustrated in FIG. 9, the registration processing section 114 registers the restriction information indicating that the maximum number of attempts for the “multiplayer” activity type is 12 and the “progress” type and the “repeatable” type activities are not allowed to play, in the restriction information holding section 130. The user B opens up the parental control setting screen 320 in the first information processing device 10 or the second information processing device 12, thereby enabling the restriction information to be updated any time.

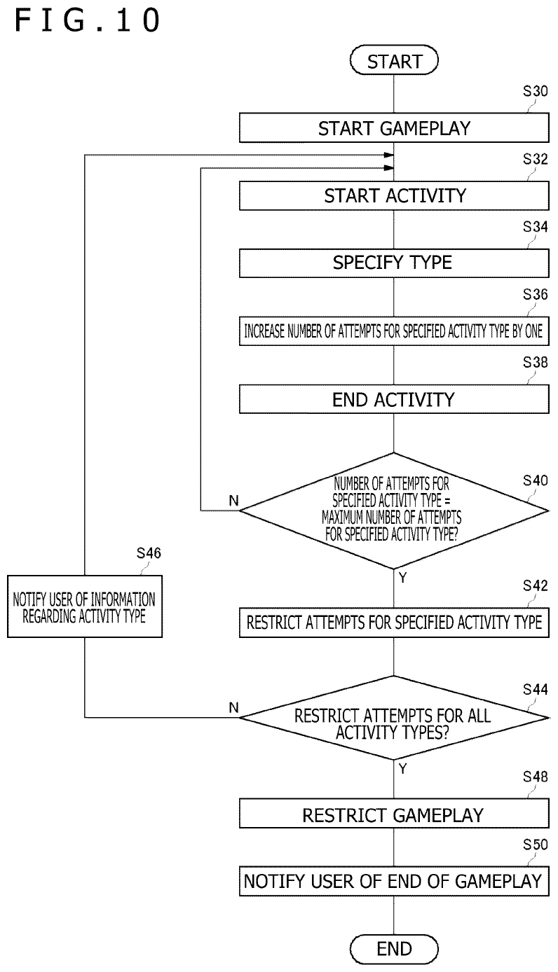

FIG. 10 indicates a flowchart for executing the parental control function in the second example. The parental control function in the second example monitors the situation of daily gameplay of the user A, and in a case in which the situation of the gameplay satisfies a predetermined restriction condition, restricts, for example, prohibits the gameplay of the user A. In the second example, the restriction information holding section 130 holds the restriction information indicating the maximum number of activity attempts for each activity type.

In this flow chart, it is assumed that the restriction information illustrated in FIG. 8 is held in the restriction information holding section 130. That is, in the title “WARSHIP3,” restriction information indicating that the maximum number of attempts for the “multiplayer” activity type is 5, the maximum number of attempts for the “progress” activity type is 4, and the maximum number of attempts for the “repeatable” activity type is 3 is registered in the restriction information holding section 130.

When the user A starts to play the title “WARSHIP3” (S30) and an activity is started (S32), the restriction processing section 112 specifies the type of the activity (S34) and increases the number of attempts for the specified activity type by one (S36). Prior to the start of the gameplay, an initial value of daily activity attempts is set to “0,” and the restriction processing section 112 counts the number of activity attempts for each type. When being provided with event information indicating that the activity has been started, the restriction processing section 112 may determine that the activity has been started. In the second example, the event information includes type information indicating the activity types, and the restriction processing section 112 refers to the type information, and specifies the activity type.

When the activity is ended (S38), the restriction processing section 112 determines whether or not the counted number of attempts for the specified type reaches the maximum number of attempts for the relevant type (S40). The restriction processing section 112 may determine that, when event information indicating that the activity has been ended is provided, the activity has been ended.

In step S40, the restriction processing section 112 acquires restriction information indicating the maximum number of attempts for the activity type which has been ended, from the restriction information holding section 130. In a case in which the counted number of attempts is smaller than the maximum number of attempts (N in step S40), the restriction processing section 112 does not restrict gameplay. Conversely, in a case in which the counted number of attempts reaches the maximum number (Y in step S40), the restriction processing section 112 restricts the attempt for the activity of the relevant type (S42). The restriction processing section 112 allows the gameplay to be continued, if the restriction processing section 112 does not restrict attempts for all the activity types (N in step S44), gameplay.

For example, when the number of attempts for the “multiplayer” type activity reaches 5 that is the maximum number of attempts, the restriction processing section 112 restricts the attempt of the “multiplayer” type activity. Conversely, the numbers of attempts for the “progress” type and the “repeatable” type activities do not reach the respective maximum numbers of attempts, the restriction processing section 112 allows the “progress” type and the “repeatable” type activities to be performed, and allows the user A to continue the gameplay.

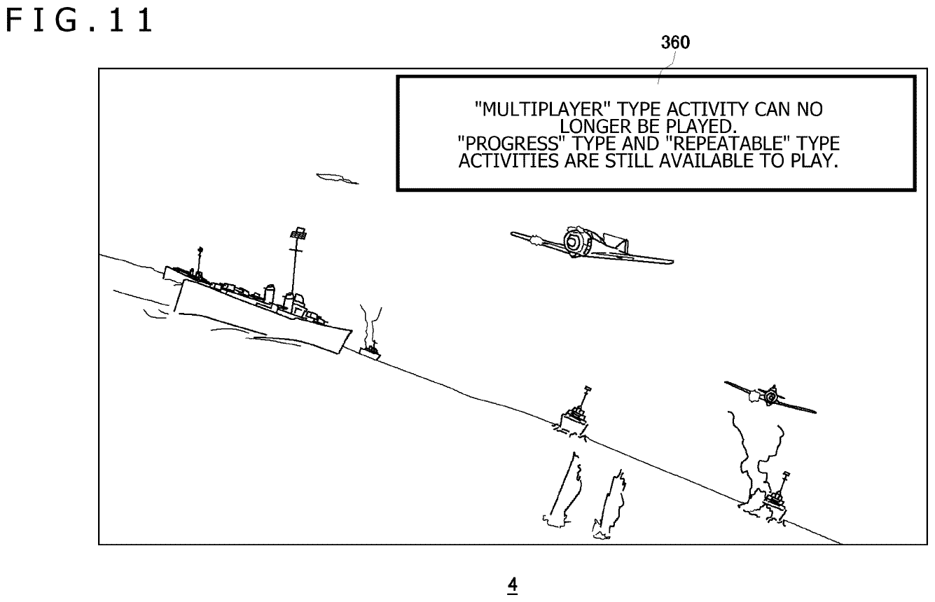

Note that, when attempt of one activity type is restricted (S42), the notification section 118 notifies the user A of information regarding the activity type (S46). FIG. 11 illustrates an example of a notification message 360. The notification section 118 notifies the user A that one activity type cannot be performed, in a predetermined region on the screen. In addition, the notification section 118 may notify the user A of the activity types which can still be performed. While the user A recognizes that the one activity type cannot be performed by viewing the notification message 360, the user A checks the activity types which are still available for play. In this example, the user A can check that the “multiplayer” type activity cannot be played and the “progress” type and the “repeatable” type activities can still be played.

When the counted number of attempts for all the types reaches the maximum number of attempts for all the types (Y in step S44), the restriction processing section 112 forcibly ends the game and restricts the gameplay of the user A (S48), and the notification section 118 notifies the user A of the end of the gameplay (S50). As such, according to the second example, the maximum number of activity attempt for each activity type is set, and the user A can perform the activity of each type within each of the maximum numbers. Compared to the time restriction under the conventional parental control, the user A can continue the activity until the end without being forced to end the gameplay midway.

In the second example, the user B sets the restriction condition for restricting daily gameplay of the user A for each game title. The user B may restrict the game titles that the user A is allowed to play. For example, it may be configured such that the user A can play only the game title on which the user B sets the restriction condition and the user A cannot play game titles on which the user B does not set the restriction condition.

### Third Example

In the third example, the restriction information holding section 130 holds a plurality of types of restriction information and according to a plurality of types of restriction conditions, the restriction processing section 112 restricts the gameplay of the user A. In the third example, the restriction information holding section 130 holds first restriction information indicating a first restriction condition for restricting the daily gameplay of the user A and second restriction information indicating a second restriction condition for restricting the daily gameplay of the user A from a viewpoint different from the first restriction condition. The first restriction condition and the second restriction condition are set on the basis of references which are different from each other. In the third example, the first restriction condition may be set according to an activity, and the second restriction condition may be set according to time.

Specifically, the first restriction condition is set to the number of attempts for an activity having reached a predetermined maximum number, and may be the same as the restriction conditions which have been described in the first and second examples. That is, the first restriction condition may be a condition set from at least one of the parental control setting screens 300, 320, 330, and 350.

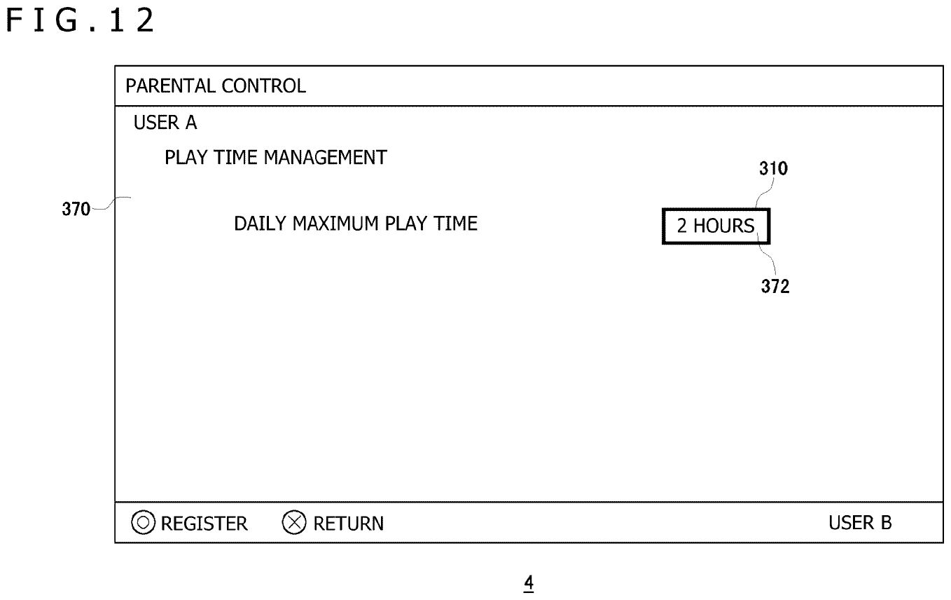

FIG. 12 illustrates an example of the setting screen of parental control for setting the second restriction condition. The screen generation section 120 displays a parental control setting screen 370 for setting the second restriction condition regarding the parental control on the output device 4. On the parental control setting screen 370, the time input field 372 is a region for setting the daily maximum play time of the user A. In the example illustrated in FIG. 12, the daily maximum play time “2 hours” is set in the time input field 372.

After the user B inputs the maximum play time in the time input field 372 and a predetermined button (for example, ○ button) of the input device 6 is operated, the registration processing section 114 registers information set on the parental control setting screen 370, as the second restriction information indicating the second restriction condition for setting daily gameplay of the user A, in the restriction information holding section 130. In the example illustrated in FIG. 12, the registration processing section 114 registers the second restriction information indicating that the maximum play time of the daily game play is 2 hours, in the restriction information holding section 130. The user B opens up the parental control setting screen 370 in the first information processing device 10 or the second information processing device 12, thereby allowing the second restriction information to be updated any time.

In the third example, while the first restriction condition regarding the activity is set for each game title, the second restriction condition regarding the time is set for the gameplay of the user A. Control on play by the restriction processing section 112 in a case in which the following first restriction condition and the second restriction condition are set will be described.

### First Restriction Condition

The maximum number of times the user A can perform the activity of the title “SAMURAI2” per day is 10.

### Second Restriction Condition

The maximum amount of time for which the user A can play the game per day is 2 hours.

The restriction processing section 112 monitors a situation of daily gameplay of the user A, determines whether or not the situation of the gameplay satisfies the first restriction condition and/or the second restriction condition, and restricts the gameplay of the user A according to a result of the determination.

Specifically, the restriction processing section 112 restricts the gameplay regarding the first restriction condition and does not restrict the gameplay other than the gameplay regarding the first restriction condition, in a case in which, while the first restriction condition is satisfied, the second restriction condition is not satisfied. In this example, when the user A performs the activity of the title “SAMURAI2” 10 times, the first restriction condition is satisfied. In this case, if the daily gameplay time of the user A does not reach 2 hours, the second restriction condition is not satisfied. Accordingly, the restriction processing section 112 may allow the user A to perform gameplay of another title until the second restriction condition is satisfied, while restricting attempts for the activity of the title “SAMURAI2.” With such play control, the user A can enjoy the game within an allowed amount of time (2 hours).

Moreover, the restriction processing section 112 may determine whether or not the user A is performing the activity regarding the first restriction condition, in a case in which the first restriction condition is not satisfied and the second restriction condition is satisfied, and may control the gameplay according to a result of the determination. In this case, if the user A does not perform the activity of the title “SAMURAI2,” the restriction processing section 112 restricts the gameplay of the user. In contrast, when the second restriction condition is satisfied (that is, when the daily play time reaches 2 hours), if the user A is performing the activity of the title “SAMURAI2,” the restriction processing section 112 does not restrict the gameplay of the user A until the activity being performed is ended. With such play control, the user A can play the activity until the end. The restriction processing section 112 may restrict the gameplay of the user A when the activity being performed is ended, even if the first restriction condition is not satisfied.

The present disclosure has been described in connection with the embodiment and the multiple examples. This embodiment and the multiple examples are illustrative, and it can be recognized by those skilled in the art that various modifications are possible in combination of the components and various processes of the embodiment and the multiple examples and also such modifications fall within the scope of the present disclosure.

In the embodiment, the first information processing device 10 is a non-portable game device, and executes a game according to an operation input of the user. In a modification example, an information processing device (cloud server) which provides a cloud gaming service to the user A may execute a game according to an operation input of the user, count the number of attempts for an activity, and restrict gameplay of the user when the counted number of attempts reaches the maximum number. In a case in which the cloud server executes the game, the first information processing device 10 operated by the user A transmits the operation input of the user A to the cloud server, receives a game image and a game sound generated according to the operation input, from the cloud server, and outputs the resultant from the output device 4. When the number of times the user A performs the activity reaches the maximum number, the first information processing device 10 restricts the gameplay of the user A.

In a case in which the cloud server executes the game, the first information processing device 10 may restrict the gameplay of the user A according to a result of a determination whether or not the situation of the gameplay of the user A satisfies the first restriction condition for restricting the daily gameplay of the user A and/or the second restriction condition for restricting the daily gameplay of the user A from a viewpoint different from the first restriction condition.

### Industrial Applicability

The present disclosure can be used to a technique for controlling gameplay of a user.

### REFERENCE SIGNS LIST

1: Information processing system
2: Auxiliary storage device
5: Server device
6: Input device
10: First information processing device
12: Second information processing device
100: Processing section
102: Communication section
110: Operation reception section
112: Restriction processing section
114: Registration processing section
116: Execution section
118: Notification section
120: Screen generation section
122: Information acquisition section
124: Transmission processing section
130: Restriction information holding section

1. An information processing device comprising:
one or more processors having hardware,
wherein the one or more processors
restrict gameplay of a user according to a result of a determination whether or not a situation of the gameplay of the user satisfies a first restriction condition for restricting daily gameplay of the user and/or a second restriction condition for restricting the daily gameplay of the user from a viewpoint different from the first restriction condition.

2. The information processing device according to claim 1,
wherein the first restriction condition is set as the number of attempts for an activity having reached a predetermined maximum number.

3. The information processing device according to claim 2,
wherein the second restriction condition is set as an amount of time for the daily gameplay having reached a predetermined maximum amount of time.

4. The information processing device according to claim 1,
wherein the one or more processors
execute a game according to an operation input of the user,
determine whether or not the situation of the gameplay of the user satisfies the first restriction condition and/or the second restriction condition, and
restrict the gameplay of the user according to a result of the determination.

5. The information processing device according to claim 1,
wherein the one or more processors do not restrict gameplay other than gameplay regarding the first restriction condition while restricting the gameplay regarding the first restriction condition, if the second restriction condition is not satisfied while the first restriction condition is satisfied.

6. The information processing device according to claim 1,
wherein, in a case in which the first restriction condition is not satisfied and the second restriction condition is satisfied, if the user is performing an activity regarding the first restriction condition, the one or more processors do not restrict gameplay of the user until the activity being performed is ended.

7. The information processing device according to claim 6,
wherein the one or more processors restrict the gameplay of the user when the activity being performed is ended, even if the first restriction condition is not satisfied.

8. A gameplay control method of controlling gameplay in an information processing device, comprising:
restricting gameplay of a user according to a result of a determination whether or not a situation of the gameplay of the user satisfies a first restriction condition for restricting daily gameplay of the user and/or a second restriction condition for restricting the daily gameplay of the user from a viewpoint different from the first restriction condition.

9. A program for a computer, comprising:
by one or more processors, restricting gameplay of a user according to a result of a determination whether or not a situation of the gameplay of the user satisfies a first restriction condition for restricting daily gameplay of the user and/or a second restriction condition for restricting the daily gameplay of the user from a viewpoint different from the first restriction condition.
